(19) United States
(12) Patent Application Publication
(10) Pub. No.: US 2011/0261026 A1
(43) Pub. Date: Oct. 27, 2011

(54) STYLUS FOR CELLULAR PHONE

(75) Inventors: Dong Sik Kim, Incheon (KR); Jong Woong No, Seoul (KR)

(73) Assignees: Seoh Technology Co., Ltd., Bucheon (KR); XG Solutions, LLC, Irvine, CA (US)

(21) Appl. No.: 12/910,435

(22) Filed: Oct. 22, 2010

(30) Foreign Application Priority Data
Apr. 22, 2010 (KR) 10-2010-0037493

(51) Int. Cl. G06F 3/033

(52) U.S. Cl. 345/179

(57) ABSTRACT

The present invention is to protect a pen tip by covering the pen tip of a touch pen used to input data on a touch screen or a touch panel with a conductive or nonconductive cap. A stylus for a cellular phone according to an exemplary embodiment of the present invention includes: a pen tip for a touch pen including a connection groove into which a stick-type pen body is fitted and a void for restoring the shape of the pen tip by elastic force at the time of touching the touch screen; a thin-film type protective cap covering the pen tip; and a pointer of which one end is connected to the pen body and the other end is fitted into the connection groove of the pen tip and preventing the pen tip from being transformed due to excessive elastic force.

### CROSS-REFERENCE TO RELATED APPLICATION

This application claims under 35 U.S.C. §119(a) the benefit of Korean Application No. 10-2010-0037493 filed Apr. 22, 2010, the entire contents of which are incorporated herein by reference.

### TECHNICAL FIELD

The present invention relates to a stylus for a cellular phone used to input data on a touch screen or a touch panel of a touch phone, or the like.

More particularly, the present invention relates to a stylus for a cellular phone capable of protecting a pen tip by covering a pen tip of a touch pen with a conductive or nonconductive cap.

### BACKGROUND ART

In general, as a stylus, a pressure type (or decompression type) stylus that applies predetermined pressure onto a touch screen to allow the touch screen to recognize the applied pressure or a capacitive stylus using static electricity are used. The stylus is classified into an internal type stylus incorporated in a cellular phone and an external type stylus separated from the cellular phone.

In recent years, a touch screen has been used as a new input type in a portable terminal such as a web pad, or the like. The touch screen input type is very convenient because a user presses portions on a screen corresponding to various icons displayed on the touch screen to execute a desired operation or program. At this time, since the web pad, or the like is manufactured in a small size to be easily carried, the screen is also small, as a result, it is difficult to control the icons with fingers.

Therefore, a touch pen is used in the touch screen input type.

Meanwhile, a protective film is attached to a glass surface of the touch screen (for example, an LCD is used) in order to prevent the glass surface from being scratched or stabbed by a tip of the stylus when the glass surface is in contact with the stylus. In this case, a pen tip made of plastic that is provided on the end of the stylus has a sphere shape so as to minimize a contact area with the protective film of the touch screen.

A conductive silicon material used as the pen tip is painted. In this case, when the pen tip repetitively contacts the touch screen, the film painted on the pen tip is easily removed due to friction. As a result, since hands or clothes are covered and contaminated with carbon that resides on the touch screen covered, reliability is deteriorated.

The above information disclosed in this Background section is only for enhancement of understanding of the background of the invention and therefore it may contain information that does not form the prior art that is already known in this country to a person of ordinary skill in the art.

### BRIEF SUMMARY

An exemplary embodiment of the present invention has been made in an effort to provide a stylus for a cellular phone capable of preventing hands or clothes from being contaminated with a pen tip by covering the pen tip of a touch pen with a thin-film type protective cap.

Further, an exemplary embodiment of the present invention has been made in an effort to provide a stylus for a cellular phone improving a contact property of a pen tip with respect to a touch screen and acquiring reliability because the pen tip is used and thereafter, the shape of the pen tip is smoothly restored.

An exemplary embodiment of the present invention has been made in an effort to provide a stylus for a cellular phone which can easily been manufactured due to a simple structure for fixing a protective cap to a pen tip.

An exemplary embodiment of the present invention provides a stylus for a cellular phone that includes: a pen tip for a touch pen including a connection groove into which a stick-type pen body is fitted and a void for restoring the shape of the pen tip by elastic force at the time of touching the touch screen; a thin-film type protective cap covering the pen tip; and a pointer of which one end is connected to the pen body and the other end is fitted into the connection groove of the pen tip and preventing the pen tip from being transformed due to an excess of the elastic force.

Another exemplary embodiment of the present invention provides a stylus for a cellular phone that includes: a pen tip for a touch pen including a connection groove into which a stick-type pen body is fitted and a void for restoring the shape of the pen tip by elastic force at the time of touching the touch screen; a thin-film type protective cap covering the pen tip; and a spring type pointer including a first pointer connected to the pen body, a second pointer fitted into the connection groove of the pen tip to face the first pointer and preventing the pen tip from being transformed due to an excess of the elastic force, and an elastic member interposed between the first and second pointers and elastically supporting the second pointer with respect to the first pointer.

At least one of the pen tip and the protective cap may be made of a conductive material.

The protective cap may be made of a conductive fiber material.

The protective cap may be made of a PET film material, PET, and a hard PVC material.

The stylus may further include a recess groove formed to correspond to an annular projection formed in an opening of the pen tip to prevent the pen tip from being removed from the pointer.

The pointer may be processed with a metallic material.

The pointer may be injection-molded by a conductive plastic material.

The pen tip is made of any one of a conductive rubber material, a conductive silicon rubber material, a conductive urethane material, a conductive PVC material, a conductive Teflon material, conductive polycarbonate (PC), and a conductive acetal (PCM) material.

A contact surface of the pen tip may be formed by an inclined surface so as to increase a touch area to the touch screen.

The contact surface of the pen tip may be formed by a gentle convex surface so as to increase the touch area to the touch screen.

The protective cap may have a thickness in the range of 0.05 to 0.2 mm.

A stylus for a cellular phone according to an exemplary embodiment of the present invention has the following advantages.

It is possible to improve a contact property of a pen tip and prevent hands or clothes from being contaminated with the pen tip by covering the pen tip for a touch screen with a thin-film type protective cap.

Further, since the pen tip is used and thereafter, the shape of the pen tip is smoothly restored to an initial state, it is possible to secure reliability even when the pen tip is repetitively used.

In addition, it is possible to improve competitiveness by saving the prime cost and manufacturing cost through a simple structure for fixing the protective cap to the pen tip.

### DESCRIPTION OF DRAWINGS

The above and other features and advantages of the present disclosure will become apparent from the detailed description of the following embodiments in conjunction with the accompanying drawings:

FIG. 1 is an exploded perspective view of a stylus for a cellular phone according to an exemplary embodiment of the present invention;

FIG. 2 is an assembled cross-sectional view of a stylus for a cellular phone according to an exemplary embodiment of the present invention;

FIG. 3 is a diagram illustrating a use state of a stylus for a cellular phone according to an exemplary embodiment of the present invention;

FIGS. 4 and 5 are modified diagrams of a pen tip in a stylus for a cellular phone according to an exemplary embodiment of the present invention; and

FIG. 6 is an assembled cross-sectional view of a stylus for a cellular phone according to another exemplary embodiment of the present invention.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

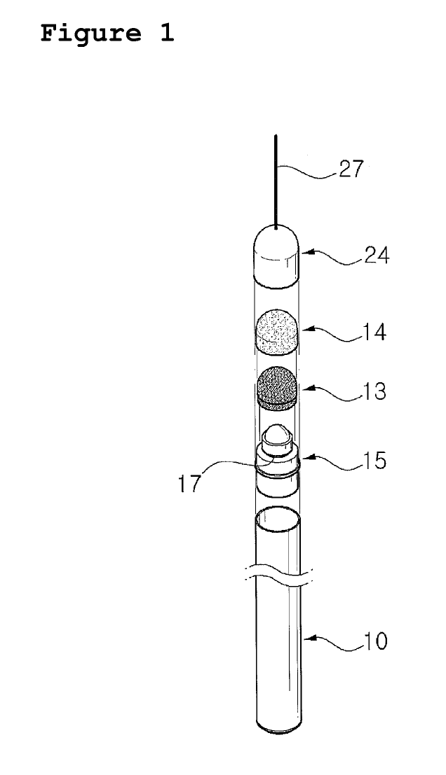

A stylus for a cellular phone according to an exemplary embodiment of the present invention shown in FIGS. 1 to 4 and 5 includes: a pen tip 13 for a touch pen including a connection groove 11 into which a stick-type hollow pen body 10 is fitted and a void 12 for restoring the shape of the pen tip by elastic force at the time of touching the touch screen; a thin-film type protective cap 14 covering the pen tip 13; and a pointer 15 of which one end is connected to the pen body 10 and the other end is fitted into the connection groove 11 of the pen tip 13 and preventing the pen tip 13 from being transformed due to excessive elastic force.

In this case, at least one of the pen tip 13 and the protective cap 14 may be made of a conductive material.

The protective cap 14 may be made of a conductive fiber material, a PET film material, PET, and a hard PVC material. In this case, the protective cap 14 may have a thickness in the range of 0.05 to 0.2 mm. When the thickness of the protective cap 14 is smaller than 0.05 mm, the protective cap 14 is very thin, as a result, manufacturability is deteriorated and the protective cap is easily broken and when the thickness of the protective cap 14 is larger than 0.2 mm, the pen tip 13 does not smoothly operate with respect to the touch screen.

The stylus 13 may further include a recess groove 17 formed to correspond to an annular projection 16 formed in an opening of the pen tip 13 to prevent the pen tip 13 from being removed from the pointer 15.

The pointer 15 may be processed with a metallic material. The pointer 15 may be injection-molded by a conductive plastic material in order to improve productivity.

The pen tip 13 may be made of any one of a conductive rubber material, a conductive silicon rubber material, a conductive urethane material, a conductive PVC material, a conductive Teflon material, conductive polycarbonate (PC), and an acetal (PCM) material.

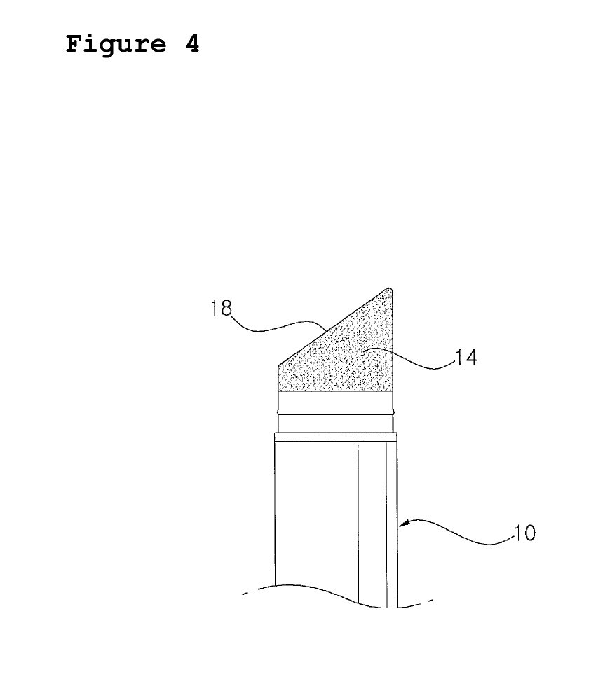

As shown in FIG. 4, a contact surface of the pen tip 13 may be an inclined surface 18 so as to increase a touch area to the touch screen.

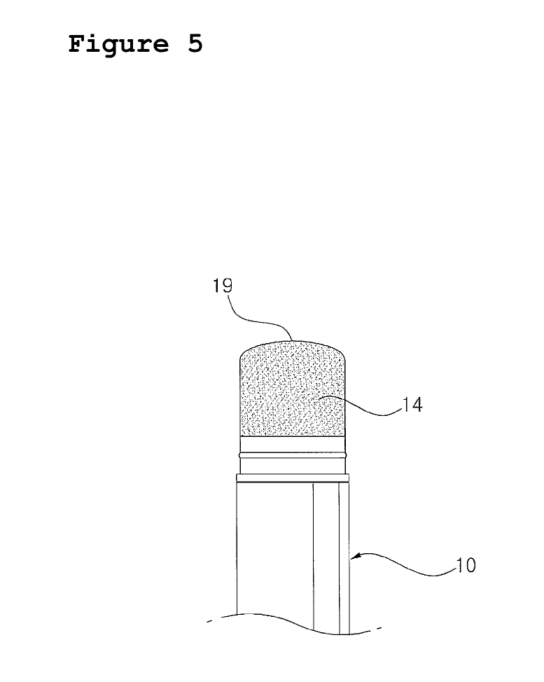

As shown in FIG. 5, the contact surface of the pen tip 13 may be a gentle convex surface 19 so as to increase the touch area to the touch screen.

In the figure, undescribed reference numeral 24 represents a cover mounted and demounted to protect the pen tip 13 and the protective cap 14, undescribed reference numeral 25 represents a projection projecting on an outer surface of the pen body 10 to correspond to an annular connection groove 26 formed on an inner surface of the cover 24 so as to prevent the cover 24 from being removed from the pen body 10, and undescribed reference numeral 27 is a string for fixing the cover 24 to the cellular phone.

Hereinafter, a use example of the stylus for the cellular phone according to an exemplary embodiment of the present invention will be described in detail with reference to the accompanying drawings.

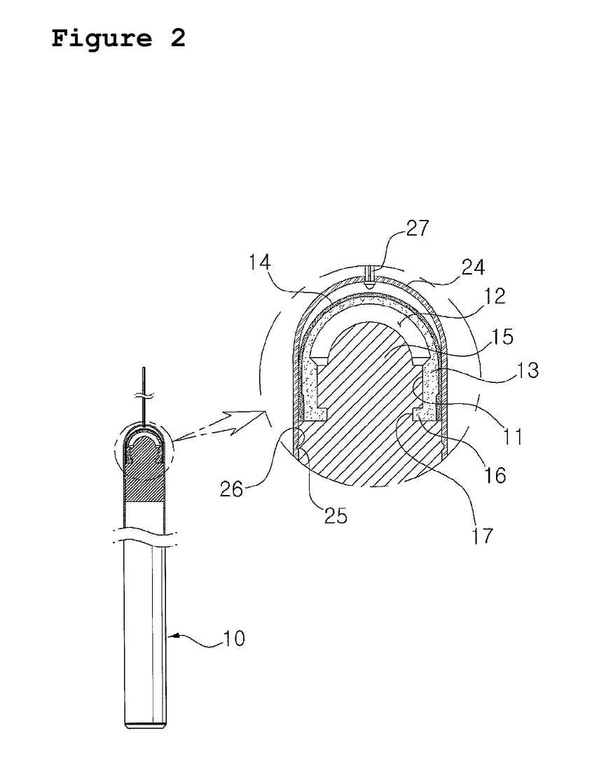

As shown in FIGS. 1 and 2, the pen tip 13 is covered with the protective cap 14, which is fixed to the pen tip 13 (a conductive adhesive may be applied onto an inner surface of the protective cap 14 so as to prevent the protective cap 14 from being separated or removed from the pen tip 13). The pointer 15 is fitted into the opening of the pen tip 13. In this case, the annular projection 16 formed at the opening of the pen tip 13 is fitted into the recess groove 17 formed in the pointer 15 so as to prevent the pen tip 13 from being removed from the pointer 15. As such, the pen tip 13 into which each of the protective cap 14 and the pointer 15 is press-fitted into and fixed to the pen body 10.

Meanwhile, when the touch pen is not used, the cover 24 is fitted into the pen body 10 so as to protect the protective cap 14 and the pen tip 13 from impurities such as dust, and the like, impact, or the like.

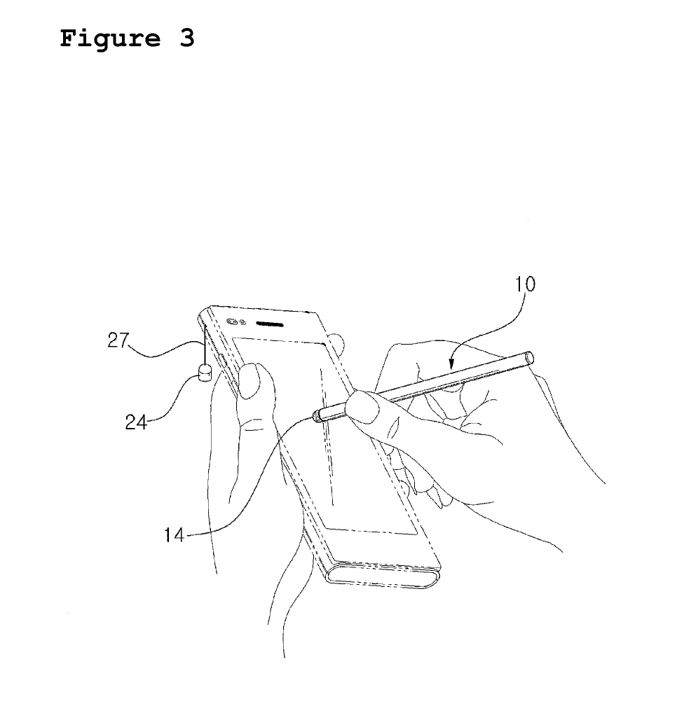

As shown in FIG. 3, when the touch screen of the web pad, or the like is touched by using the touch pen, the cover 24 is removed from the pen body 10. That is, the pen tip 13 touches a corresponding icon on the touch screen while the pen body 10 is gripped. In this case, the friction of the pen tip 13 with respect to the touch screen is decreased by the thin-film type protective cap 14 covering the pen tip 13, thereby improving a contact property.

Meanwhile, the shape of the pen tip 13 that touches the touch screen is restored to an initial state by its own elastic force. That is, the shape of a contact portion of the pen tip 13 that is elastically transformed to sink inward when the touch screen is touched with a void 12 formed at the inside of the pen tip 13 is restored to an initial state.

As a result, even when a pressing portion of the pen tip 13 repetitively touches the touch screen, the shape of the pen tip 13 is restored to the initial state, which is convenient for a user.

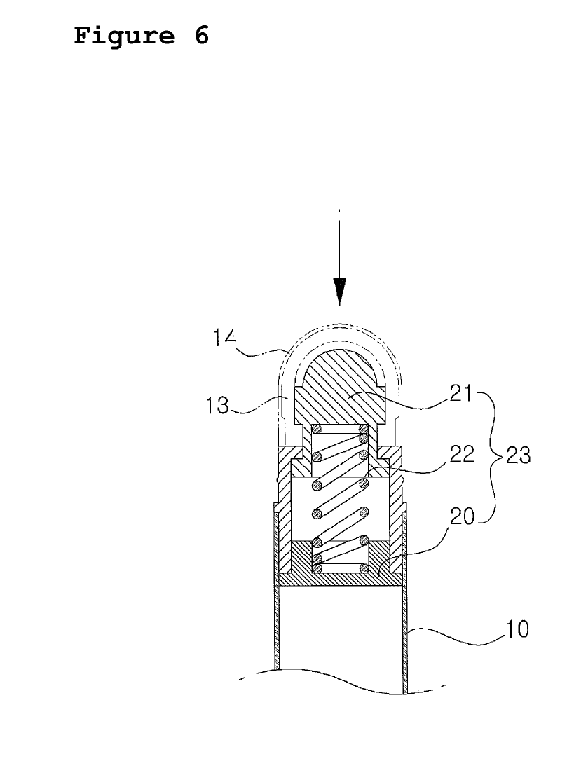

A stylus for a cellular phone according to another exemplary embodiment of the present invention shown in FIG. 6 includes: a pen tip 13 for a touch pen including a connection groove 11 into which a stick-type pen body 10 is fitted and a void 12 for restoring the shape of the pen tip by elastic force at the time of touching the touch screen; a thin-film type protective cap 14 covering the pen tip 13; and a spring type pointer 23 including a first pointer 20 connected to the pen body 10, a second pointer 21 fitted into the connection groove 11 of the pen tip 13 to face the first pointer 20 and preventing the pen tip 13 from being transformed due to an excess of the elastic force, and an elastic member 22 (for example, a compression coil spring is used) interposed between the first and second pointers 20 and 21 and elastically supporting the second pointer 21 with respect to the first pointer 20.

In this case, since a configuration without the spring-type pointer 23 constituted by the first and second pointers 20 and 21 that are divided to face each other is the same as the configuration of the stylus according to the exemplary embodiment of the present invention, detailed description of the configuration and operation will be omitted and like elements refer to like reference numerals.

When the protective cap 14 or the pen tip 13 is weak in its own elastic force, thus, the restoration force of the pen tip is deteriorated, the pen tip 13 is forcibly pressed in a direction opposite to the pen body 10 at all times by the elastic force of the elastic member 22 interposed between the first and second pointers 20 and 21. As a result, after the pen tip 13 touches the touch screen, the shape of the pen tip 13 may smoothly be restored to the initial state.

As described above, according to a stylus for a cellular phone according to an exemplary embodiment of the present invention, it is possible to improve a contact property of a pen tip by covering the pen tip for a touch screen with a thin-film type protective cap, repetitively use the pen tip because the pen tip is used and thereafter, the shape of the pen tip is smoothly restored to an initial state, and it is possible to save the prime cost and manufacturing cost through a simple structure for fixing the protective cap to the pen tip.

Although some embodiments have been described in the present disclosure, it should be understood that the embodiments are given by way of illustration only and do not limit the scope of the present disclosure, and that various modifications, changes and variations can be made by a person having ordinary knowledge in the art without departing from the spirit and scope of the present disclosure, which are limited only by the accompanying claims and equivalents thereof.

### [Sequence List Text]

10: PEN BODY

11: CONNECTION GROOVE

12: VOID

13: PEN TIP

14: PROTECTIVE CAP

15: POINTER

16: PROJECTION

17: RECESS GROOVE

18: INCLINED SURFACE

19: CONVEX SURFACE

20: FIRST POINTER

21: SECOND POINTER

22: ELASTRIC MEMBER

23: SPRING TYPE POINTER

1-14. (canceled)

15. A stylus pen for a cellular phone, comprising:
a pen tip for a touch pen including a connection groove into which a stick-type pen body is fitted and a void for restoring the shape of the pen tip by elastic force at the time of touching the touch screen;
a thin-film type protective cap covering the pen tip; and
a spring type pointer including a first pointer connected to the pen body, a second pointer fitted into the connection groove of the pen tip to face the first pointer and preventing the pen tip from being transformed due to excessive elastic force, and an elastic member interposed between the first and second pointers and elastically supporting the second pointer with respect to the first pointer.

16. The stylus pen for a cellular phone according to claim 15, wherein at least one of the pen tip for a touch pen and the protective cap is made of a conductive material.

17. The stylus pen for a cellular phone according to claim 16, wherein the protective cap is made of a PET film material, PET or a hard PVC material.

18. The stylus pen for a cellular phone according to claim 15, further comprising a recess groove formed to correspond to an annular projection formed in an opening of the pen tip to prevent the pen tip from being removed from the second pointer.

19. The stylus pen for a cellular phone according to claim 15, wherein at least one of the first and second pointers is made of a metal material.

20. The stylus pen for a cellular phone according to claim 15, wherein at least one of the first and second pointers is made of a conductive plastic material.

21. The stylus pen for a cellular phone according to claim 15, wherein the pen tip for a touch pen is made of any one of a conductive rubber material, a conductive silicon rubber material, a conductive urethane material, a conductive PVC material, a conductive Teflon material, conductive polycarbonate (PC), and a conductive acetal (PCM) material.

22. The stylus pen for a cellular phone according to claim 21, wherein the pen tip for a touch pen has an inclined contact surface so as to increase a touch area with respect to a touch screen.

23. The stylus pen for a cellular phone according to claim 21, wherein the pen tip for a touch pen has a gentle convex contact surface so as to increase the touch area with respect to the touch screen.

24. The stylus pen for a cellular phone according to claim 15, wherein the protective cap is made of a conductive fiber material.

25. The stylus pen for a cellular phone according to claim 15, wherein the protective cap has a thickness in the range of 0.05 mm to 0.2 mm.
